(19) United States
(12) Patent Application Publication
(10) Pub. No.: US 2014/0259678 A1
(43) Pub. Date: Sep. 18, 2014

(54) Shavers

(71) Applicant: Future Wave Products, Inc., Escondido, CA (US)

(72) Inventors: Kenneth J. Hegemann, Escondido, CA (US); Tiana L.K. Buschmann, Steamboat Springs, CO (US)

(73) Assignee: Future Wave Products, Inc., Escondido, CA (US)

(21) Appl. No.: 14/070,220

(22) Filed: Nov. 1, 2013

Related U.S. Application Data
(63) Continuation-in-part of application No. 29/449,907, filed on Mar. 15, 2013.

(51) Int. Cl. B26B 21/22

(52) U.S. Cl. CPC B26B 21/222
USPC 30/50

(57) ABSTRACT

Systems, methods and devices for shaving including one or more of a curved shaving cartridge, a process of manufacture thereof; and a double cartridge shaving device and methods of use and/or manufacture thereof.

### BACKGROUND

Advances in shaver technologies and materials have led to a plethora of developments in shaver and related products and processes. In particular, many variously shaped and alternatively functioning shaving devices are becoming available for a variety of shaving applications. However, improvements may yet be desired for shaver devices that provide effective shaver controls, in some cases, also with increased efficiency, ease and/or comfort. Further alternatives for shavers and their users may, in some implementations, then include simplifications for use and/or efficiency.

### SUMMARY

Described herein are alternative shaving devices and/or systems, and/or methodologies in some instances for efficiency and/or simplification in use, and/or in shape and/or multiple interactive co-activity for simplified and/or improved usage. A number of alternative implementations and applications are summarized and/or exemplified herein below and throughout this specification.

These as well as other aspects are exemplified in a number of illustrated alternative implementations and applications, some of which are shown in the figures and characterized in the claims section that follows. However, as will be understood by the ordinarily skilled artisan, the above background, summary and the detailed description below do not describe the entire scope of the inventions and/or developments hereof and are indeed not intended to describe each illustrated embodiment or every implementation of the present disclosures nor provide any limitation on the claims or scope of protection herein set forth below.

### BRIEF DESCRIPTION OF THE DRAWINGS

The drawings include:

FIG. 1, which includes sub-part FIGS. 1A-1H, illustrates several implementations of the present developments, including various of isometric, top and bottom plan and several elevational views of a shaver device hereof.

FIG. 2, which includes sub-part FIGS. 2A-2H, provides isometric views and schematic plan views of a device hereof and isometric and plan views and a flowchart of a method of assembly of a device or portion of a device hereof.

FIG. 3, which includes sub-part FIGS. 3A-3H, provides isometric and elevational views of a shaver device and elevational and isometric and schematic views and a flowchart of a method of use of a shaver device hereof.

FIG. 4, which includes sub-part FIGS. 4A-4J, provides isometric, plan and elevational views of a shaver device and portions hereof, and a methodology associated herewith.

FIG. 5, which includes sub-part FIGS. 5A and 5B, provides each of an isometric and an elevational view of an alternative shaver device hereof.

### DETAILED DESCRIPTION

While the inventions hereof are amenable to various modifications and alternative forms, specifics thereof have been shown by way of example in the drawings and the following description. It should be understood, however, that the intention is not to limit the inventions to the particular embodiments described. The intention is to cover all modifications, equivalents, and alternatives falling within the spirit and scope of the inventions whether described here or otherwise being sufficiently appreciable by skilled artisans as included herewithin even if beyond the literal words and/or drawing figures hereof.

In one aspect, a device hereof may be a curved shaving cartridge, and/or may include one or more methods for manufacture or use thereof. In another, aspect, a system hereof may include a double cartridge shaving device which in some implementations may include one or more curved shaving cartridges. In some implementations, a double cartridge shaving device having a main body portion which has as parts thereof a handle and a plurality of shaving cartridge connection implements. In such cases, first and second shaving cartridges may be attached or attachable to the main body portion via the plurality of shaving cartridge connection implements. In many instances, the first and second shaving cartridges may be disposed in pivoting relationship relative to the main body portion, and/or in many cases, the main body portion and/or the plurality of shaving cartridge connection implements can be configured so the first and second shaving cartridges are disposed with sufficient distance therebetween so that each of the first and second shaving cartridges co-acts with the other of the second and first shaving cartridges, during a shaving operation, to maintain each of the first and second shaving cartridges in a desirable operative angular position relative to the work surface. In some implementations, the shaving cartridges of a double cartridge device are curved shaving cartridges. Also, often the main body and/or connection implements are configured to dispose the first and second cartridges substantially in line with each other. A double cartridge shaving device may further be configured such that the cartridges are detachably attachable to the main body via the connection implements. Some other non-exhaustively listed alternative implementations will be described hereinbelow.

FIGS. 1 and 2 illustrate initial examples of alternative implementations of devices or portions of devices that may be so adapted or configured.

FIG. 1 shows a device or cartridge 100 that has a shaving side or top side 101, a bottom side or connection side 102, and one or more cutting devices or razor blades, generally identified by the references 103 and 104 here (a double bladed razor cartridge is shown and described herein although many other configurations and numbers of blades per cartridge may be substituted in minimally acceptable alternatives). (Note, top and bottom and any other descriptors of relative orientation or position are not intended to be limiting and are merely provided here for quick appreciation of the drawings—many of these orienting descriptors will not remain viable as the devices are moved through various phases of use and/or manufacture.) A leading edge structure 106 and trailing edge structure 107 of the cartridge 100 are also shown (leading and trailing here referring to direction of use, in shaving, for example). FIG. 1A shows isometrically these together with some other elements that may be used herewith or may be parts hereof. Although not described in detail with respect to FIG. 1, these cartridges may be disposed to have or be formed using a single base or body, generally identified by the reference 110; or may be or include two sub-parts 210 and 250, which may have been previously otherwise discrete or separate from each other as will be described below. FIGS. 1B and 1C are more specifically directed to a top or shaving side 101 in respective elevational and plan views; and FIGS. 1D and 1E to an underside, or connection side 102 plan and elevational views; and FIG. 1F to a rear isometric view. FIGS. 1G and 1H show respective side elevations. Note, FIGS. 1D and 1F show some back or connecting side features which will be described further below. Of note, are two connection apertures 150 and 151 and four receiving and/or alignment holes 160, 161, 162 and 163. A transverse notch 150a (opening of notch defined by the curved structure indicated at 150a) is shown at least partially connection aperture 150 in FIG. 1F for connection to a transverse latch portion of a cartridge holder, as described below. A similar notch 151a in connection aperture 151 (not apparent in FIG. 1F) is also preferably disposed, and is shown in more detail in FIG. 2A, see description below (notch opening defined by curved structure indicated by 151a). Protrusions 152, 153, also shown most prominently in FIG. 1F, may abut or otherwise be adjacent latches described and shown below (see FIG. 4), and may provide or assist in the swiveling or pivoting action allowed/provided by/to the cartridge when connected to a shaving handle or like device/structure. They may also help guide the latches 450, 451 (and/or 452, 453; see further detailed description of these latches below, FIG. 4) for example into the pockets 150 and 151. This may provide easier entry of the latches into the cartridge pockets. They may also and/or alternatively, at least provide maintenance of some operable distance between the cartridge and handle/device for use.

As introduced above, the cartridge may be a unitary device 110 formed curved with blades therein, and/or may become a unitary member formed from a previously formed blade set 250 and a base or body portion 210 of a cartridge which may also have been separately formed, particularly in and/or for an exemplar process of generation of a cartridge 100 hereof (combined member 110 of body 210 and blade set 250 as introduced in FIG. 1A). In some implementations, where for example, the cartridge 100 may be curved as shown in FIG. 1, a body 210 may be pre-formed in and/or to a curved disposition as shown in FIG. 2, see particularly, FIG. 2A. In some implementations, this base may be made of a rigid or substantially rigid, or at least perhaps of a resilient, but, pre-curved form as shown. Then, a blade set 250 such as that shown, front and back isometric views in respective FIGS. 2B and 2C, may then be connected to the base 210. The blade-holding structure 251, which holds the blades 103, 104 (noting that one or more blades, not limited to two, may be used within the scope hereof), may be pre-formed curved in a fashion co-operative with base 210, or may be made initially straight (perhaps more typically straight to abide or tolerate conventional straight razors during this initial part of the forming process). When/if made straight, the blade-holding structure would be durable, yet sufficiently flexible or resilient such that it may flex to the curved disposition shown and described here.

In a process of achieving a cartridge hereof, a respective exploded, exemplar connection disposition is shown in FIG. 2D with a curved base 210 and a sufficiently flexible or resilient blade set 250. In a bit more detail, the schematic plan of FIG. 2E illustrates that the respective rivet pegs 260, 261, 262 and 263 may be moved toward and mated with or inserted in the receivers 160a, 161a, 162a and 163a of FIG. 2E (note, receivers 160a, 161a, 162a and 163a may be separate/discrete from or otherwise may be contiguously defined with and/or as the four receiving and/or alignment holes 160, 161, 162 and 163 of FIG. 1; here, they are not necessarily so defined as, but, could be through-holes defined through the body 210, as appears for the examples of FIG. 1 and not inconsistent with that shown in FIG. 2A). The blade set base structure 251 is sufficiently flexible to flex or bend so that it fits to the curved disposition of the pre-formed body 210. Flex arrows 20a and 20b are shown in FIG. 2E adjacent set 250 to indicate direction of flex in moving the blade set 250 into position adjacent and relative to body 210. The blade set 250 is moved (see movement arrows 21a, 21b) toward base 210 (though an opposite movement of base 210 to set 250 is also viable), and the pegs 260-263 are then inserted in the respective receivers 160a-163a and a combination base/set 110 of a formed curved cartridge 100 is completed as schematically shown in FIG. 2F. The peg/receiver combinations are denominated 160a/260, 161a/261, 162a/262, 163a/263 in FIG. 2F. The pegs inserted in the receiving holes may then be fixed in place by a number of alternatives including for non-limiting examples, gluing, welding, sonic welding, or cold rivet forming. An exemplar final combination cartridge 100 formed this way is shown in FIG. 2G.

A method summary 200 is shown in FIG. 2H where a first operation is of constructing or otherwise obtaining a curved base portion with peg receivers and constructing or otherwise obtaining a blade set with rivet pegs; a second operation 202 includes inserting the blade set rivet pegs into base peg receivers; and a third operation 203 is for fixing blade set rivet pegs within receivers. Note, discrete manufacturing processes may be used for the first two operations, thus, the first may be optional as to construction as to the end producer, thus, the dashed line connection of operation 201 to 202. Either the respective formed shapes of the respective parts and/or the respective materials to accomplish the manufacture may provide some or all of the capabilities described. E.g., a relatively rigid polypropylene may be selected for the body 210 for relatively simple manufacture and desirable shape retention. Then, a flexible blade body 251 may be selected from a relatively flexible material, or one with sufficient plasicizer added to provide flexibility, as with plasticized acrylonitrile butadiene styrene (ABS) or polypropylene or plasticized poly vinyl chloride (PVC) as some non-limiting examples. Relative structure size and/or shape could also and/or alternatively provide flexibility for the blade set body 251, as for example with sufficient thinness along and/or relative to the length such that the blade set 250 is flexible enough to be disposed as described. Flexible razor blades as are known would also be preferably used to achieve the curved disposition. In an example, a pre-formed straight, i.e., non-curved razor cartridge may first be constructed such as blade set 250 as shown in FIG. 2. Then, this blade set, which would be as blade set 250, can then be attached to a body 210 as described above. Alternatively, a unitary member 110 could be formed with blades inserted or otherwise attached, without a two-step process (202 and 203) as described here.

In FIG. 3, an exemplar implementation of a device 300 is shown wherein two cartridges 100a and 100b are disposed in operative relationship relative to each other connected to or as disposed as part of the double cartridge device 300. Device 300, as described herein, provides relatively simple user control over the blade angles, for efficient cutting operation. So long as a user provides a light but sufficient pressure on the device 300 toward a work surface to place both cartridges in cutting operational contact with the work surface, then, the relative positions and dispositions of the cartridges and the device 300 maintain the cartridges in preferable cutting angles. Such can be used for a variety of cutting operations; however, might provide greater utility for use in shaving a head such as a human head. This may be particularly true due to some of the challenges provided in shaving a head such as maintaining proper cutting angles using otherwise conventional shaving devices. Further details related hereto are set forth in the following.

As shown in FIG. 3, see particularly at least initially, FIGS. 3A, 3B and 3C; device 300 includes a base or body portion 310 and a handle portion 301. Directional arrows 31a, 31b indicate the operational movement direction of the device during a cutting/shaving operation. The underside of the device 300 has a plurality of shaving cartridge connection implements or latches (not readily viewable in FIG. 3, but described in further detail, see FIG. 4, below) which provide for attachment, preferably detachable attachment, of the blade cartridges 100a, 100b thereto. A generalized view is shown in the isometric of FIG. 3A, and some additional details can be found in the respective side and front elevations of FIGS. 3B and 3C. E.g., a desirable pivoting relationship is indicated by pivot arrows 30a, 30b in FIG. 3B, and the blades 103, 104 of the cartridge 100a may be seen ready for use in FIG. 3C, inter alia.

In some implementations, a double cartridge shaving device 300 may have a main body portion 310 having as parts thereof or attached thereto a handle 301 and a plurality of shaving cartridge connection implements or latches (not separately viewable in FIG. 3, but see description in FIG. 4 below); and, first and second shaving cartridges 100a, 100b detachably attached to the main body portion via the plurality of shaving cartridge connection implements or latches. In many cases, the first and second shaving cartridges 100a, 100b are disposed in swiveling or pivoting relationship relative to the main body portion 310; this being shown schematically in FIGS. 3A and 3B by the respective pivot arrows 30a and 30b wherein one or both of the main body and the plurality of shaving cartridge connection implements are configured to dispose the first and second shaving cartridges so that each of the first and second shaving cartridges co-acts with the other of the second and first shaving cartridges, during a shaving operation, to provide a self-adjusting, self-controlling maintenance of each of the first and second shaving cartridges in a desirable operative angular position relative to the work surface. In some implementations, there is set a sufficient distance between the cartridges so that proper cutting angles are maintained. More details on this and other operability are set forth below.

Some initial ready alternative combinations hereof may include one or more of: 1) a double cartridge shaving device wherein the first and second shaving cartridges are curved shaving cartridges (as shown); or, 2) where the cartridges may be substantially straight, and/or may even be flexible, resilient, straight or curved; 3) a double cartridge shaving device wherein the first and second shaving cartridges are substantially non-linearly disposed or rather in line with each other as shown in FIG. 3; 4) a double cartridge shaving device wherein the cartridges are detachably attachable to the main body via the connection implements or latches; and 5) a double cartridge shaving device wherein the work surface is one or more of skin, human skin, a human face and a human head.

FIGS. 3D and 3E show some examples of use of a device 300, as for instance, here, on work surface 1001 that is here a human head 1001. In FIG. 3D, shown is the device 300 in travel over the surface 1001, leading or first cartridge 100a traveling over the surface with trailing or second cartridge 100b following therebehind. As this is an inline implementation, cartridge 100a is linearly in front along the operational path of travel; although non-linear options may also be available. A forward directional arrow 32 is shown in FIGS. 3D, 3E, to indicate the direction of forward cutting operational movement. In this example, the device 300 is also shown with curved cartridges (as from FIGS. 1 and 2), with the double cartridges in line with each other, one in front of the other, the other trailing the one in front. In this example, the human head may thus be shaved using device 300. Note, non-in-line examples may be effectuated as well, as for example where one or more additional or alternative leading or trailing cartridges may be offset from the line of shaving attack used by the other of the trailing or leading cartridge(s).

A downward force or pressure representation in arrow 33 is also shown in FIG. 3D. This relative downward (could be other directions not limited to down; the indication ultimately must merely be representative of the relationship of the force toward the work surface) force may preferably be applied by a user, pressing upon handle 301 in the direction of the work surface; thereby moving the body 310 and ultimately both cartridges into and maintaining them in contact with the work surface 1001. In a relatively foolproof operation, the user must merely maintain appropriate minimum contact pressure, pressing the handle 301 into making both the cartridges thereby maintain working contact with the work surface. The user may then rest assured that appropriate angulation or angles of cutting operation will be maintained as described herein. This may be referred to as self-adjusting, self-controlling or self-setting.

FIG. 3E provides a few additional details in a usage example like that in FIG. 3D. In FIG. 3E, operation of the device 300 as preferred with both cartridges 100a and 100b is shown relative to a working surface 1001, here also a human head (though other surfaces can be used as well, faces, arms, legs, etc.). In this example, as the device 300 is moved in travel over the surface, moved by user in relative direction of arrow 32 (other directions will also occur, when the device is properly oriented facing those other directions). In this example, the respective pivoting cartridges 100a, 100b (pivoting discretely on/by their own pivot references 30a, 30b) are shown as they adopt differing angles of shaving attack relative to the body and/or handle of the device 300. Cartridge 100a is shown with a slightly obtuse angle alpha, a, relative to the device 300 vertical (approximated by the disposition of the handle). (Note, a different reference, as for example using the relative horizontal of the device body 310 could alternatively have been used as well.) However, the cartridge 100b is shown with its slightly acute angle beta, β, relative to the device vertical as well. Both angles are within allowances of the respective pivot paths 30a and 30b. Achievement of the appropriate, though at times distinct, angles for cutting operation is not user controlled other than by the user simply applying the above-introduced relative downward pressure on the device 300/310, as along arrow 33, to ensure that both cartridges are disposed in substantially constant operative contact with the work surface/skin. The cartridges as they swivel and are maintained in relative position, relative to each other by body 310, will then adopt sufficient and appropriate cutting angles relative to the work surface. Again, this is not due to user selection of angle through user manipulation of the device, other than for the user to push the device toward the skin. In this sense, operator error is removed, and a relatively fool-proof operation can be obtained.

In use, the pivoting and the maintenance of both cartridges in operative contact with the work surface may provide for keeping the cartridges effectively operating at appropriate angles of shaving attack. This maintenance may be substantially continuous. Thus, each cartridge provides control over and/or to the other cartridge to maintain proper shaving angles or angulation. Conceptually, without the substantially simultaneous contact by both cartridges, one or the other of the cartridges could be disposed, accidentally or otherwise, at too large or too small of an angle, thereby rendering the blades either ineffectively not in appropriate cutting contact with the work surface, or alternatively, angled too directly into the skin and not efficiently operative to move along and over the surface. The pivoting cartridges and the shapes of the cartridges can co-act to maintain efficient, comfortable cutting angles but for situations where the operating device is moved beyond the angle accommodated by the pivot. If, for example, the operating device is moved to an angle past the pivot angle to lift the blades of one or the other cartridge off the work surface, then, little or no cutting will take place; however, if/when the rear of an operating device is lifted too much past the pivot angle, then, the blades will be directed to dig into the work surface. Examples of this are shown in FIG. 3F, which includes and is defined by sub-part FIGS. 3Fi, 3Fii, and 3Fiii; where in FIG. 3Fi, one of a limited range of appropriate, desirable cutting angles is maintained with the blades running substantially along the contour of the work surface without loss of efficiency or undue cutting into the work surface. FIG. 3Fii shows an angle of attack in which the cutting portions of the blades are rotated to be lifted from the cutting surface and no longer effective to cut at the surface of the work surface. FIG. 3Fiii shows the opposite, too steep of an attack angle wherein the blades are disposed to undesirably cut into the work surface.

In more particulars, blades 104, 103 are shown in each of FIGS. 3Fi, 3Fii, 3Fiii relative to a work surface (e.g., could be skin) 1001. In FIG. 3Fi, the cutting angle θ1 is shown small relative to the work surface (relative to likely a tangent or like definition of the work surface at the point of contact). Thus, in FIG. 3Fi, with maintained small divergences in cutting or attack angle θ1, preferred blade contact can be made for good cutting. Both blades (could be more or less blades in any given example) would also be maintained in good cutting disposition as shown schematically in FIG. 3Fi.

Contrarily, the too large angle θ2 shown in FIG. 3Fii, and the negative, or otherwise too small (i.e., negative) or too large angle θ3 of FIG. 3Fiii would generate the inefficient, ineffective or even possibly dangerous cutting angles shown. Also if multiple blades are used, one or the other of those would be thrown even that much further away from the cutting surface if the cutting angle is not sufficiently controlled.

In many cases, the cartridge leading edge 106 and trailing edge 107 can provide the angular control for blades. An example of such is as is shown in a part of FIG. 3G, which includes and is defined by sub-part FIGS. 3Gi, 3Gii, 3Giii, and 3Giv; see initially particularly sub-part FIG. 3Gi. In FIG. 3Gi, when both the leading and trailing edge structures 106, 107 (shown schematically in dashed lines in FIG. 3Gi, as the exact structures used are less concerning than the existence and operational maintenance thereof relative to the other elements as described here) are maintained in substantial/operative contact with the working surface 1001, then, the blades 104, 103 will likewise be appropriately so maintained. An angle θ1 is shown here also where the divergence from the work surface (tangential or other definition) is maintained such that the blades are maintained as preferred for efficient cutting.

If however, and as is the case with many conventional shaving devices, either the leading or the trailing edge structure is not maintained in work surface contact, then undesirable cutting angles may be obtained. Both examples are shown in FIG. 3Gii, in which a device handle 510a is shown lowered or pushed forward too far so that the trailing structure 107 of cartridge 600a is lifted out of contact with the work surface creating an undesirable negative (or otherwise too large) cutting angle like angle θ3 in FIG. 3Fiii. And, also in FIG. 3Gii, a device/handle 510b is shown lifted too much so that the leading edge structure 106 is lifted out of contact with the work surface, raising the angle of attack too much, not unlike that of angle θ2 of FIG. 3Fii. Note, only a single blade 104 is shown in the example cartridges 600a, 600b, but is done so for ease of illustration and without limitation away from multiple blade alternatives; i.e., multiple blade cartridges would suffer like those shown and described here. This is true also for the example of FIGS. 3Giii and 3Giv below; i.e., the presence of single blades therein does not limit the description thereto as multiple blade examples can also be used therein. Note also, the handles 510a and 510b are not connected to each other operatively or otherwise in this example of FIG. 3Gi.

However, as shown in the example of sub-part FIG. 3Giii, if two cartridges 600c, 600d can be connected, via body 510c, and here, connections 510d and 510e (non-limitative example connections), and with some minimal amount of available pivoting 30a, 30b, then, desirable cutting angles can be maintained. In this case, when both cartridges are maintained in contact with the work surface 1001, then, neither will achieve the extreme angles of FIG. 3Gii. Another way to view this, is to note that if cartridge 600d is maintained in contact with the work surface 1001, then, when cartridge 600c is also in contact, the angle for 600c will be controlled/maintained at or within desirable minimums such as angle θ1. In this way, cartridge 600d “controls” the angulation or angular disposition of cartridge 600c. Similarly, when cartridge 600c is maintained in work surface contact, it maintains/controls the disposition of cartridge 600d so that cartridge 600d is maintained in the desirable range of cutting angles θ1, when cartridge 600d is also in work surface contact. Cartridge 600c thus controls cartridge 600d. Note, this is similar to the operation of the cartridge leading and trailing surfaces 106, 107 (see FIG. 3Gi) when both are maintained in substantive/operative contact with the work surface; however, in this case, shaving operations are also effectuated by each of the contact members, distinctive from the non-cutting operations of the mere leading and trailing surfaces 106, 107.

Note here also/again; the disposition of cartridges 600c, 600d in maintained contact can be achieved simply by the user simply applying a relative downward pressure on the device 510c toward the work surface to ensure that both cartridges are maintained in substantially constant operative contact with the work surface/skin. The pivoting/float of the respective cartridge provides the remainder correction to appropriate angles. Moreover, so long as both cartridges are in contact, then, neither can move to an angle beyond the desired limited range θ1. Each cartridge provides this governance effect on the other. Downward pressure is the functional/user input with no necessary thought, or skill to achieve relative foolproof operation.

Note, the pivoting as indicated by 30a and 30b provides in FIG. 3Giii for local maintenance of the respective leading and trailing edge structures 106, 107 to be in substantial simultaneous work surface contact to maintain preferred cutting angles for the respective blades 104 (and others if used also). The maximum range of pivot angles do not allow for the respective cartridges to achieve the undesirable angles of FIG. 3Gii, and yet allow for relative freedom, or even float, relative to the structure 510c. Here again, so long as each of the other cartridges relative to each other is also maintained in work surface contact, then, each cartridge will be maintained within and not be allowed to move outside a desirable minimal range of pivoting toward maintenance of a desirable cutting angle not unlike angles θ1. It might be noted that structure 510c may/will achieve a variety of angles relative to the work surface; however, so long as both cartridges remain in surface contact, operation remains as desired. If, however, structure 510c is tilted too much either in one relative direction or the other, then, foolproof operation is no longer necessarily the result. Rather, if an up-tilted end of the structure 510c leads to having either cartridge leave the work surface, then, operation may no longer be as desired. However, up to the point of, and preferably for some range immediately after a tilting of structure 510c, a cartridge leaving the work surface will nevertheless leave the work surface before the maximum pivot angle for the other still contacting cartridge is exceeded to drive that still contacting cartridge through to an undesirable extreme angle of attack. This is shown in more detail in FIG. 3Giv where body 510c is shown tilted forward too much, thus outside desired foolproof operation, the back end thereof lifting the rear cartridge 600d away from and out of contact with the work surface. However, through this rotation of 510c, the front cartridge 600c is still in contact with the work surface with both the leading and trailing edges 106, 107 thereof still within work surface contact and thus maintaining a desirable angle; this is maintained through an initial rotation of device 510c toward this position due to at least minimal pivot range availability. But, with rear cartridge 600d out of contact with the work surface, if tilting of 510c continues, then, front cartridge 600c is at risk for being moved beyond the tolerance of the pivot ability thereof to maintain a good cutting disposition. In such a position, rear cartridge 600d is no longer able to or otherwise in control of the disposition of cartridge 600c. Even so, correction can/would occur so long as and/or as soon as rear cartridge 600d is put back in contact with the work surface. Then, front cartridge 600c would no longer be at risk for moving to an undesirable cutting angle. A similar action/re-action would occur with a tilt of device 510c in the other direction lifting front cartridge off the surface.

In the present implementations of FIGS. 3 (and 4, see below), when both cartridges are maintained on or in operative contact with the work surface, the angles of attack are not exceeded by either cartridge. Most directly, so long as the trailing cartridge is maintained in work surface contact, by simple user-applied down force on handle 301 (no necessary user thought or angle selection necessary), the rear of the device 300 is not thereby lifted too high such that the front cartridge would be put at risk of taking too steep an angle of attack and cutting the work surface, as in the example of FIG. 3Fiii; and, similarly, by maintaining the front cartridge in substantial constant work surface contact, by the same, self-same, singular down force applied by the user (without other thought or angle selection), the front of the device 300 is not lifted too high relative to the trailing cartridge such that the blades thereof are lifted to the inefficient cutting angle shown in FIG. 3Fii. In this way, then, each of the cartridges provides control to the other cartridge to maintain proper cutting angles or angulation. The front cartridge controls the back cartridge when it stays in contact, and the back cartridge controls the front cartridge similarly, merely by remaining in work surface contact. This is self-controlling or self-adjusting for substantially foolproof operation without the user having to think about or determine or manually provide desirable angles for cutting.

Thus, a double cartridge shaving device hereof may be disposed such that the first and second cartridges are disposed such that each is simultaneously in contact with the work surface during operation, and with sufficient minimum force to maintain each cartridge in work surface contact such that each cartridge maintains the other in sufficiently appropriate cutting disposition when each are simultaneously in contact with the work surface. The device 300 can achieve these controls by being configured wherein when the one or both of the main body and/or the plurality of shaving cartridge connection latches are configured to dispose the first and second shaving cartridges so that each of the first and second shaving cartridges co-acts with the other of the second and first shaving cartridges, during a shaving operation, the first and second shaving cartridges so that each cartridge maintains the other in sufficiently appropriate cutting disposition. It may also be that the first and second cartridges may be set with sufficient distance therebetween to achieve these ends.

A summary methodology 400 is non-limitatively set forth in FIG. 3H, wherein a first operation 401 involves the grasping, holding or otherwise obtaining a double cartridge shaver, typically, though not necessarily by/through human manipulation; the second operation 402 includes applying the cartridges to a work surface with both cartridges simultaneously in contact therewith through application of a minimum force toward the work surface, and a third operation 403 includes establishing in cutting operation of appropriate blade angles, each cartridge controlling the other.

Non-limiting examples for connecting cartridges and/or providing replacement cartridges are shown and described relative to FIG. 4. In particular, in FIG. 4A, shown is a partially exploded view of the underside of a double cartridge shaver 300 with cartridges 100a and 100b disassociated from the body 310. Cartridge connection implements or latches (not detailed in FIG. 4A, but, see FIG. 4B, inter alia, below) are disposed on this underside 311 of the body 310. Also shown here is an optional disk-like body 410, which in some implementations may be, as shown in FIG. 4, a relatively fixed part of or connection to body 310, or may be a removable/re-connectable part, which in some cases, may provide an alternative for cartridge replacement. In some implementations, the cartridges 100a, 100b may be replaceable by being connected to implements/latches which are a substantially a contiguous part of body 310, or as shown below may be connectable to connection implements that are part of or otherwise connected to the disk 410.

As shown in FIGS. 4A and 4B, body 410 may be connected or connectable or detachably attachable to main body 310, and, in the preferred implementation here, is connected to and made integral with body 310, with nevertheless in the example hereof, movable parts relative thereto. As introduced above, the body 310, and/or, as here, body 410 may have one or more cartridge connection implements or latches 450, 451, 452, 453 disposed thereon or as a part thereof. These latches 450, 451, 452, 453 could alternatively be part of body 310 directly, or when body 410 becomes integral with body 310, then, may be said to be parts of either or both. Moreover, these latches 450, 451, 452, 453 are configured to co-actively/cooperatively engage connection apertures 150, 151, and particularly to hook inside respective notches 150a, 151a. Further details hereof are set forth below.

FIG. 4C shows the same parts relative to body 410, though disassociated from body 310, for simplicity in description only. FIGS. 4D and 4E are bottom and top plan views, respectively, of the disk body 410 and FIGS. 4F and 4G provide front and side elevations respectively. FIGS. 4H and 4I show respective front and side attachments of the cartridges 100a and 100b to a disk 410. With cartridges so attached and/or attachable to disk 410, a relatively simple and simultaneous removal and/or replacement of both cartridges may be effectuated. Note, in an unshown alternative, cartridges might be attachable to a separate/separable disk 410 by removal from and/or replacement of disk 410 into body 310. However, in the shown alternative, cartridge replacement can take place with operative disposition attached to body 310 as described below.

One or more protrusions 415a, 415b (see FIG. 4C for examples) may be disposed on disk 410 and may engage with corresponding reduced area receiving apertures (not separately shown) in body 310 to fix disk 410 relative to body 310. Or, pegs 416a, 416b (see FIG. 4B) which are parts of body 310 may be used to connect body 410 thereto by being inserted in respective apertures 417a, 417b (see FIG. 4C) and fixed by cold rivet forming, sonic welding or otherwise.

Disk 410 may have as shown resilient arms 420, 421 that may be manipulated by activation of or pressing upon respective finger/thumb portions 430, 431 in the direction of the respective arrows 40a, 41a, which achieves relative rotational resilient movement of the arms along the directions of arrows 42a, 43a. Reduced areas 422, 423 may be established to provide or assist in provision of the resilience of the arms 420, 421; or, otherwise, other relative shapes and/or the materials selected might provide the degree of resilience desired.

Resilient arms of disk 410 may be manipulated to disengage or engage the latches from or with the respective cartridges to remove or to engage them therewithin during replacement. Corresponding finger/thumb engaging portions 330, 331 on body 310 may be simultaneously manipulated with portions 430, 431 to effectuate the relative rotation of the arms 420, 421. The net effect of such movements would be to move respective latches 450, 452 away from corresponding respective latches 451, 453 to provide for dis-engagement of the latches from the notches of the cartridges. A relative engagement with a cartridge 100a/b is shown in FIG. 4H. Engagement with two cartridges 100a, 100b is shown in FIG. 4I.

In a little more detail, if a user engages, as for example between the fingers and thumb of one hand, the respective finger/thumb-engaging portions 330 and 430 (works also for portions 331/431, which could be separately engaged, or might even be simultaneously engaged, as for example by the user's other hand), and then, by squeezing, the portion 430 (and/or 431) would move toward the portion 330 (similarly for 331) as by the arrow of movement 40a (41a for portions 431 toward 331). This then causes the rotational movement 42a of the arm 420 (similarly 43a of arm 421), about the relative pivot/flex point/area 422 (or point/area 423 for arm 421). These movements are shown in FIGS. 4B, 4C, 4D, 4F and 4H (though the flexpoints and rotational movements are not seen in FIGS. 4F and 4H). These movements of the arms 420/421 are within and relative to the otherwise relatively non-moving body 310 (non-moving relative to the arms, though could be moving in space). The result is also a movement of the latch 450 (or 452 for portions 331/431) outwardly shown by the arrow(s) 40c (and 40d). This outward movement might also been seen by reference to FIGS. 4F and 4H. Note, it may be either or both the relative shape/structure of the body 410 and arms 420, 421 as connected thereto, and/or the materials selected for use herein (polypropylene is one acceptable example) that may be chosen to provide the desired resilience for the arms to move as shown and described when manipulated by the finger/thumb engagement portions 330/430 and/or 331/431.

As perhaps best shown in FIG. 4H, latch 450 may be manipulated as described here so that it may be introduced or removed from a corresponding receiving aperture 151 in cartridge 100a (aperture 151 shown in dashed lines in FIG. 4H); particularly such that latch hook 451a can either engage or disengage (whether for attachment or removal, respectively) with the laterally notched opening 151a, and relatively lock therein and thereagainst, unless and until the manipulations (squeezing the relative handholds 330/430 or 331/431 to disengage) are completed again. Note, a certain minimum length of latch members 450, 451, 452, 453 and relative depth of receiving apertures 150, 151 as defined by lateral notches 150a, 151a, relative to the thickness or height of the hook portions 450a, 451a (interalia) may also provide for some allowable, often desirable lengthwise, up and down (up and down is relative to the work surface, rather as in a direction toward or away from, though here also not for losing contact therewith) (relative tilt is also relative to the body 310 of device 300) as indicated generally by arrow 40e. An extra degree of freedom or float for the cartridges may be provided hereby.

A sample methodology 500 for replacement of cartridges is shown for example in FIG. 4J; first 501 involving a user grasping at least one finger/thumb engagement portion; second 502 involving squeezing the finger/thumb portion to move resilient arm and associated latch; and third 503 involving engaging and/or disengaging the cartridge for either or both removal of a spent cartridge and/or replacing with a new cartridge.

Introduced in FIG. 4C (though also shown in FIGS. 4A and 4B, inter alia) are respective optional alignment pins 470, 471, 472 and 473 which may be used to align respective cartridges 100a, 100b for attachment. The alignment pins may be disposed or configured to mate with, though not fill completely, respective receivers 161, 162 of cartridges 100a, 100b (see FIGS. 1D and 1F, e.g.). As may be seen in FIG. 4H, pins 470, 471, e.g. may be configured to be able to be inserted in respective receivers 161, 162. Note, receivers 161, 162 are not aligned with receiving apertures 150, 151, however, they may be set to have a relationship that can be mirrored by the latches 450, 451 and pins 470, 471 such that the cartridge can only be engaged by all four when the device 300 and cartridge 100 are aligned for proper forward operative/operable movement, i.e., for cutting operation when the device 300 is moved forward as shown in FIG. 3. In such an implementation, the cartridges cannot then be attached in reverse; however, there may be implementations where it may be disposed or desirable to make alternative rear facing an option, for either one or both cartridges.

An alternative handle 700 is shown in FIGS. 5A and 5B; this being shown to exemplify other operating devices that may make use of a curved cartridge 100 hereof. Pivoting as shonw in FIG. 5B may be effective herewith as well.

The components described above are meant to exemplify some types of possibilities. In no way should the aforementioned examples limit the scope of the invention, as they are only exemplary embodiments.

Embodiments of the present inventions relate to devices, systems, and arrangements for shavers and methods for manufacture and methods of shaving, inter alia. While detailed descriptions of one or more embodiments of the inventions have been given above, various alternatives, modifications, and equivalents will be apparent to those skilled in the art without varying from the spirit of the inventions. Therefore, the above description should not be taken as limiting the scope of the inventions, which are defined by the appended claims.

1. A double cartridge shaving device comprising:
a main body portion having as parts thereof or attached thereto;
a handle and
a plurality of shaving cartridge connection latches; and,
first and second shaving cartridges attached to the main body portion via the plurality of shaving cartridge connection latches, the first and second shaving cartridges being disposed in pivoting relationship relative to the main body portion;
wherein one or both of the main body portion and the plurality of shaving cartridge connection latches are configured to dispose the first and second shaving cartridges so that each of the first and second shaving cartridges co-acts with the other of the second and first shaving cartridges, during a shaving operation, to maintain each of the first and second shaving cartridges within a range of desirable operative angular positions relative to a work surface.

2. A double cartridge shaving device according to claim 1 wherein the main body portion is configured to be subjected to a singular force directing the main body toward the work surface.

3. A double cartridge shaving device according to claim 1 wherein the main body portion is configured to be subjected to a singular force directing the main body toward the work surface; and wherein the force is directed to bring both cartridges into contact with the work surface.

4. A double cartridge shaving device according to claim 1 wherein the main body portion is configured to be subjected to a singular force directing the main body toward the work surface; and wherein the force is directed to bring both cartridges into contact with the work surface, and to maintain both cartridges in contact with the work surface.

5. A double cartridge shaving device according to claim 1 wherein the first and second shaving cartridges are curved shaving cartridges.

6. A double cartridge shaving device according to claim 1 wherein the first and second shaving cartridges are one or more of straight, flexible, resilient and flexible or resilient straight or curved shaving cartridges.

7. A double cartridge shaving device according to claim 1 wherein the first and second shaving cartridges are substantially in line with each other.

8. A double cartridge shaving device according to claim 1 wherein the cartridges are detachably attachable to the main body via the connection latches.

9. A double cartridge shaving device according to claim 1 wherein the work surface is one or more of skin, human skin, a human face and a human head.

10. A double cartridge shaving device according to claim 1 wherein when the one or both of the main body and the plurality of shaving cartridge connection latches are configured to dispose the first and second shaving cartridges so that each of the first and second shaving cartridges co-acts with the other of the second and first shaving cartridges, during a shaving operation, the first and second shaving cartridges are set with sufficient distance therebetween so that each cartridge maintains the other in sufficiently appropriate cutting disposition.

11. A double cartridge shaving device according to claim 1 wherein the first and second cartridges are disposed such that each is disposed simultaneously in contact with the work surface during operation, and that each cartridge maintains the other in sufficiently appropriate cutting disposition when each are simultaneously in contact with the work surface.

12. A double cartridge shaving device according to claim 1 wherein the first and second cartridges are disposed connected to a removable disk body which is attachable to the main body of the device.

13. A double cartridge shaving device according to claim 1 wherein the first and second cartridges are disposed connected to a non-removable disk body which is attached to the main body of the device.

14. A double cartridge shaving device according to claim 1 further comprising:
first and second movable arms to each of which at least one cartridge connection latch is connected;
wherein the first and second cartridges are disposed to be connected using the at least one cartridge connection latches on each of the first and second arms.

15. A double cartridge shaving device according to claim 1 further comprising:
first and second movable arms to each of which at least one cartridge connection latch is connected;
wherein the first and second cartridges are disposed to be connected using the at least one cartridge connection latches on each of the first and second arms; and
wherein movement of either of the first and second arms moves that arm and the connection latch theron to provide for engagement or disengagement of the latch with the cartridge.

16. A double cartridge shaving device according to claim 1 further comprising:
first and second movable arms to each of which at least one cartridge connection latch is connected; and,
a finger/thumb engagement portion on at least one of each of the first and second movable arms, the finger/thumb engagement portion providing for user manipulation to move the respective first or second arm;
wherein the first and second cartridges are disposed to be connected using the at least one cartridge connection latches on each of the first and second arms.

17. A double cartridge shaving device according to claim 1 further comprising:
first and second movable arms to each of which at least one cartridge connection latch is connected; and,
a finger/thumb engagement portion on at least one of each of the first and second movable arms, the finger/thumb engagement portion providing for user manipulation to move the respective first or second arm;
wherein the first and second cartridges are disposed to be connected using the at least one cartridge connection latches on each of the first and second arms; and
wherein movement of either of the first and second arms moves that arm and the connection latch theron to provide for engagement or disengagement of the latch with the cartridge.

18. A double cartridge shaving device according to claim 1 further comprising:
first and second movable arms to each of which at least one cartridge connection latch is connected; and,
a finger/thumb engagement portion on at least one of each of the first and second movable arms, the finger/thumb engagement portion providing for user manipulation to move the respective first or second arm; and,
a finger/thumb engagement portion on the main body portion, disposed to co-operative with the finger/thumb engagement portion on the at least one of each of the first and second movable arms;
wherein the first and second cartridges are disposed to be connected using the at least one cartridge connection latches on each of the first and second arms.

19. A double cartridge shaving device according to claim 1 further comprising:
one or more alignment pins for aligning a cartridge for forward use.

20. (canceled)

21. (canceled)

22. (canceled)

23. (canceled)

24. (canceled)

25. A shaving system comprising:
two curved blade cartridges disposed to control each other, wherein the angle of disposition of one cartridge is controlled by the location of the other;
a double cartridge shaving device according to claim 1 wherein the double cartridge shaving device is configured to provide for the two curved blade cartridges to each be disposed in substantially constant operative contact with a work surface and thereby control and maintain the angulation of each of the respective two curved blade cartridges.

26. (canceled)

27. (canceled)

28. (canceled)
